(19) United States
(12) Patent Application Publication
(10) Pub. No.: US 2014/0090566 A1
(43) Pub. Date: Apr. 3, 2014

(54) APPARATUS FOR PRODUCING BAKED PRODUCTS

(71) Applicant: HAAS FOOD EQUIPMENT GMBH, Wien (AT)

(72) Inventors: Johann Haas, Klosterneuburg (AT); Josef Haas, Leobendorf (AT); Stefan Jiraschek, Koenigsbrunn (AT); Martin Kopf, Goesing am Wagram (AT)

(73) Assignee: HAAS FOOD EQUIPMENT GMBH, Wein (AT)

(21) Appl. No.: 14/116,443

(22) PCT Filed: May 4, 2012
(86) PCT No.: PCT/EP2012/058204

§ 371 Date: Nov. 8, 2013

(30) Foreign Application Priority Data
May 10, 2011 (AT) A 660/2011

(51) Int. Cl. A21B 3/00

(52) U.S. Cl. CPC A21B 3/00
USPC 99/342

(57) ABSTRACT

A device for producing baked products, in particular edible crisp wafers or soft waffles, contains at least one baking plate, the baking surface of which can be heated to a baking temperature. The baking plate has a sensor device for detecting the temperature of the baking plate and/or a pressure acting on the baking surface of the baking plate during the baking process.

The invention relates to an apparatus for producing baked products, in particular edible crispy wafers or soft waffles, where at least one baking plate, preferably moved through the baking chamber during baking, is provided, whose baking surface can be heated to baking temperature.

Such apparatuses are in particular wafer baking ovens. Wafer baking ovens having circulating baking tongs have been known for a long time for the industrial production of wafers of any kind. Furthermore, it is also already known to measure and regulate the oven temperature in order to achieve a good baking process. However, the temperature measurements at the present time are always made only indirectly by infrared heat sensors which are disposed in the oven chamber and measure the temperature, for example, on the rear side of the baking plate. A disadvantage here is the great inertia of the system and this temperature measurement gives no information on the temperature profile during the baking process in the plate and certainly not at the baking surface.

The measurement of the pressure which occurs in the closed baking tongs has so far not been made at all in industrial baking processes and has not been used to control the baking process. This applies particularly to baking tongs which are guided through a baking chamber of the oven, where cabling is not possible as in stationary baking ovens.

The baking process can be varied or disturbed by many factors, resulting in defective baking processes and increased wastage. For example, the dough composition can vary in regard to water content or flour quality or other dough factors. Furthermore, as a result of contamination, e.g. by sticking baking residues, multiple injections can occur on the baking plates with the result that not only the baking product becomes unusable but also the baking plate and the mechanical parts of the tong carriage can become damaged.

Hitherto, many of these disturbances of the baking process could only be determined after the baking process by means of the defective baking products, with the result that particularly in the case of fast-running baking ovens, considerable wastage occurs.

It is therefore the object of the present invention to avoid the said disadvantages by taking measurements during the baking process by measuring pressure and/or temperature directly in the baking plate and as close as possible to the baking surface and thereby have the possibility of controlling the baking parameters in good time. In the event of a set-point value deviation, the operator of the baking oven should be able to regulate the parameters such as temperature, amount of dough, recipe and belt speed, for example, by means of the measurement data. Furthermore contaminations, wear effects and double injections thereby caused can be avoided. One aim is also the fully automatic regulation of the baking oven control by means of the measured parameters.

The apparatus according to the invention is intended to be used for all baking ovens in which regulation using the parameters temperature and pressure is appropriate. In particular, these are wafer baking ovens for the production of crispy flat wafers, wafer products having three-dimensional shaping, flat baking products which are shaped three-dimensionally in the heated state after the baking process, and also soft waffles. The industrial technical operating mode of these baking ovens is accomplished by means of circulating baking tongs which are arranged in a row, where the baking tongs each comprise an upper and a lower baking plate and the baking tongs are opened for receiving dough, pass through the baking chamber after closing, and after baking of the product are opened again to remove the baking product, then cleaned and supplied to the dough application station again. This prior art is already described, for example, in AT 378 470 B1 and the similar U.S. Pat. No. 4,438,685.

The invention solves the formulated object whereby at least one baking plate is provided whose baking surface can be heated to baking temperature, where the baking plate has a sensor device for detecting the temperature of the baking plate and/or of the pressure acting on the baking surface of the baking plate during the baking process. The sensor device contains at least one sensor. The sensor is preferably disposed in a sensor receiving opening in the baking plate so that the sensor lies with its sensor head in the baking surface or comes to lie in close proximity to the baking surface. The sensor receiving opening is configured to extend from the rear side of the baking plate to a measuring section in close proximity to the baking surface, where the baking surface and the measuring section run through continuously.

Alternatively the sensor receiving opening can penetrate from the rear side of the baking plate through the baking plate where the sensor head lies with its sensor membrane in the baking surface and is profiled the same as this.

The measuring section of the sensor receiving opening can have a stamp projecting towards the sensor head or the sensor membrane thereof for transmitting the measurement values acting on the measuring section. Alternatively, the sensor membranes can have a stamp projecting towards the measuring section. The measuring section has, for example approximately a wall thickness between 1 and 3 mm.

The sensor receiving opening can be configured as a blind hole projecting into the baking plate and the sensor with its sensor body can be cylindrically shaped and fastened in the baking plate by means of an annular clamping element. Furthermore, the sensor is a passive temperature-pressure sensor which can preferably be interrogated by means of an electromagnetic field, which on its rear side has a sensor antenna for transmission of energy and information. The sensor antenna is an H-slot antenna. A reflector plate is disposed below the sensor antenna which is fastened to the sensor body or its shaft.

One or more reading devices are assigned to the sensor, which produce and evaluate the electromagnetic field. The sensor is adapted to deliver information relating to pressure, temperature and an identification feature characteristic of the sensor. The baking plate can also have a plurality of sensors. The baking plate can be part of baking tongs circulating in the baking oven, which each comprise a lower and an upper baking plate where the baking tongs in the closed position loaded with dough are movable through the baking chamber. The sensor device can consist of one or more sensors on the upper and/or lower baking plate. At least one of the baking tongs circulating in the baking oven is provided with at least one sensor device. A plurality of or all the baking tongs of a baking oven can be provided with a sensor device. In the baking oven a position display displaying the position of each baking tong and its baking plates provided with the sensor device is preferably provided in order to be able to assign each measured value read by the reading device to a specific baking plate and baking tong and its position in the baking oven. One or a plurality of reading devices are provided consecutively in the baking chamber and the successively read measured values and the identification features of the sensor devices of the baking plate(s) are fed to an evaluation device. Advantageously SAW sensors based on piezoelectric substrate crystals are used as sensors. Furthermore, the apparatus is preferably a baking oven for producing baked products which are formed in a baking tong between two successively disposed baking plates, wherein the baking oven has an oven frame provided with an external thermal insulation and baking tongs circulating in the baking oven are provided, which are disposed along an orbit leading through the baking chamber of the baking oven and which are conveyed by the conveying device of the baking oven along the orbit through the baking oven, wherein in the oven frame on a part of the orbit of the baking tongs disposed outside the baking chamber, a device for opening the baking tongs, a dispensing station for the baked products, a loading station for loading the baking tongs and a device for closing the baking tongs in the running direction of the baking tongs are disposed consecutively and wherein there is provided a monitoring device integrated in the baking oven, which detects the work activity of the baking oven and the baking process taking place in the baking tongs, which is provided with:

(a) a sensor device which comprises at least one sensor disposed on a baking tong, which detects the baking process taking place in the baking tong, which is configured as a passive sensor which can be interrogated by an electromagnetic field,

(b) a transmitting and receiving device which is disposed fixedly in the baking oven and comprises at least one reading device disposed on the orbit of the baking tong chain, which communicates via the electromagnetic field with the sensor of the sensor device and

(c) an evaluation device which processes the signals coming from the sensor via the reading device and produces monitoring signals.

Further features of the invention can be deduced from the claims, the following description and the drawings.

The invention is explained in detail hereinafter with reference to the drawings.

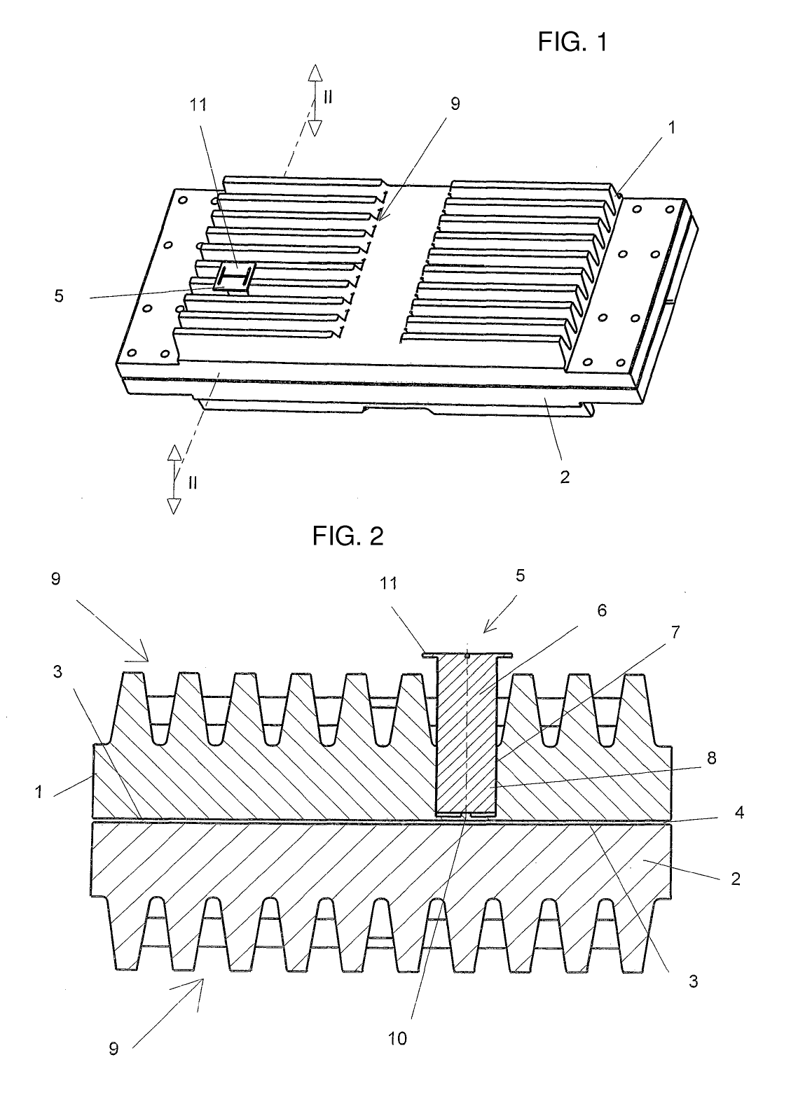

FIG. 1 shows an oblique view of two closed baking plates which are assigned to one another and

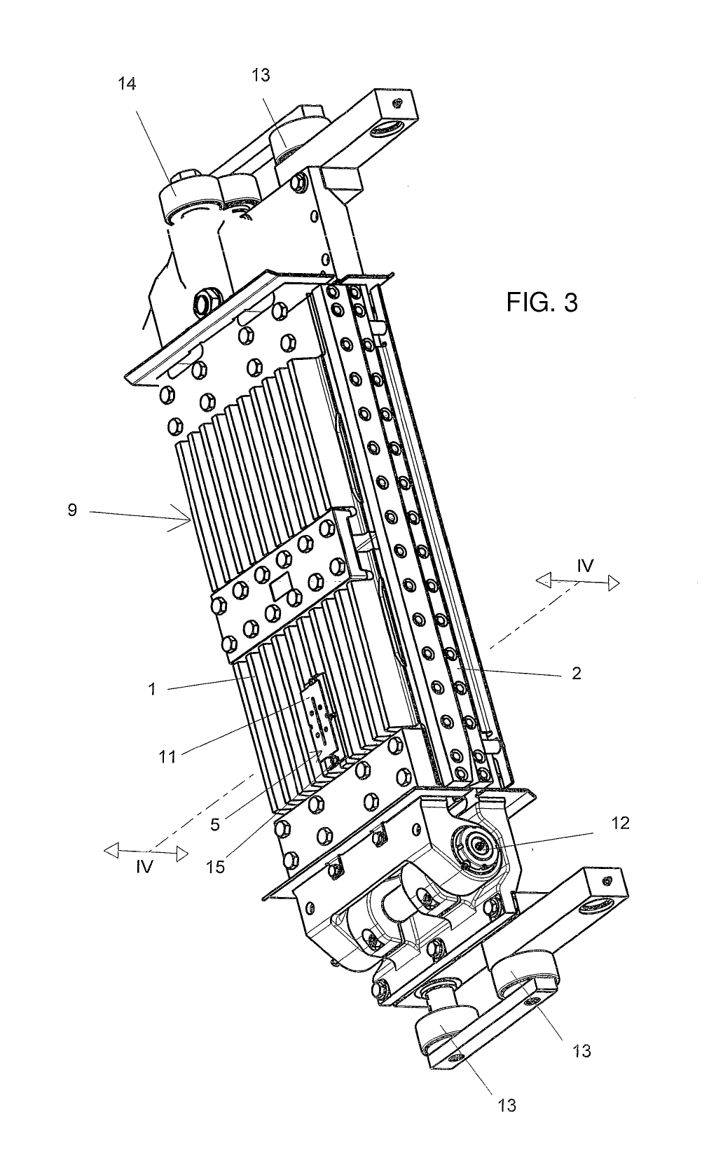

FIG. 2 shows a section along the line II-II in FIG. 1.

FIG. 3 shows an oblique view of a baking tong according to the invention and

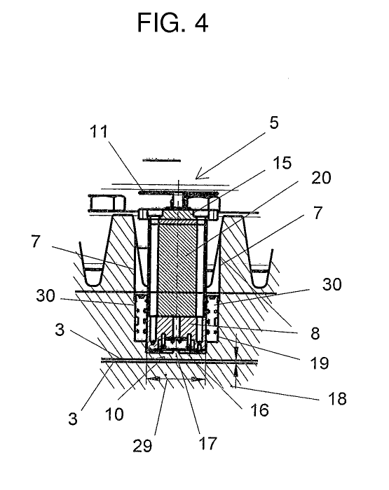

FIG. 4 shows a section of a cross-section along line IV-IV in FIG. 3.

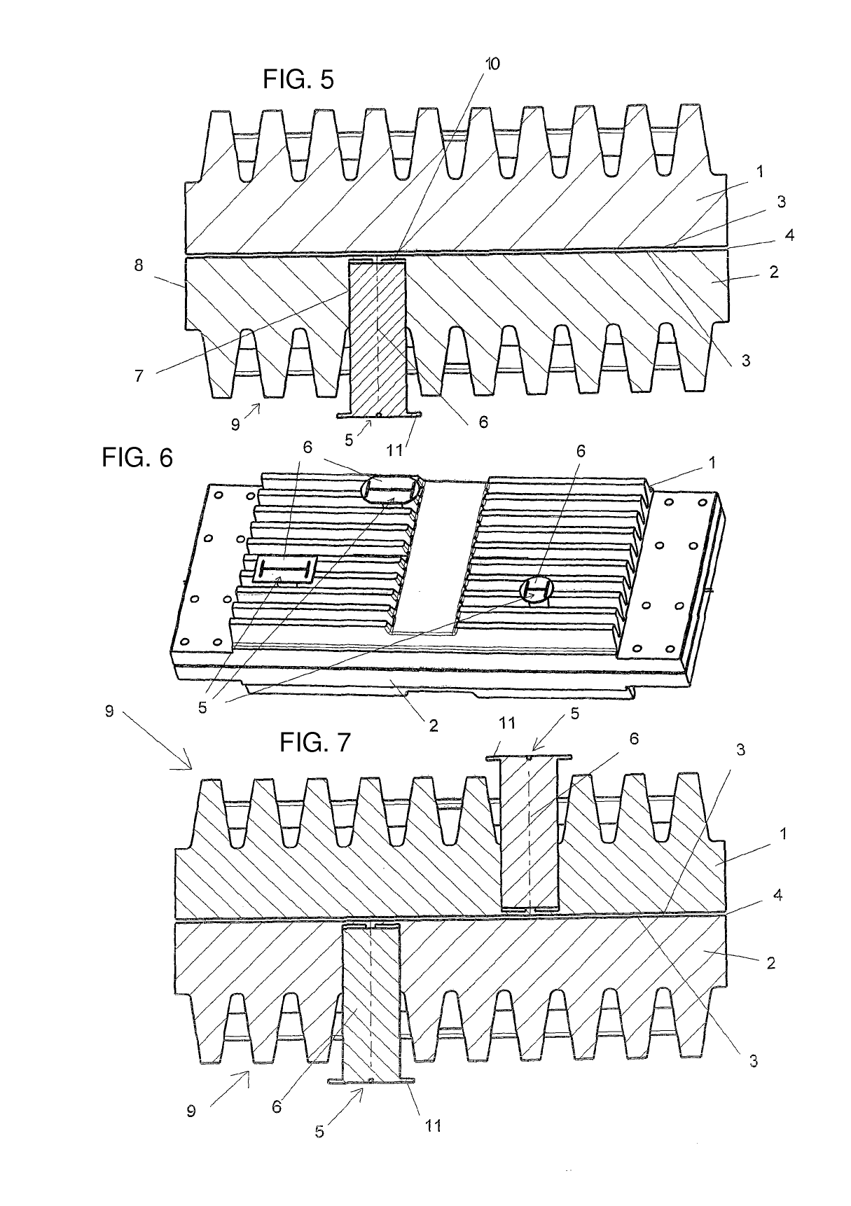

FIG. 5, FIG. 6 and FIG. 7 show various exemplary embodiments with different arrangements of the sensors in the baking plates.

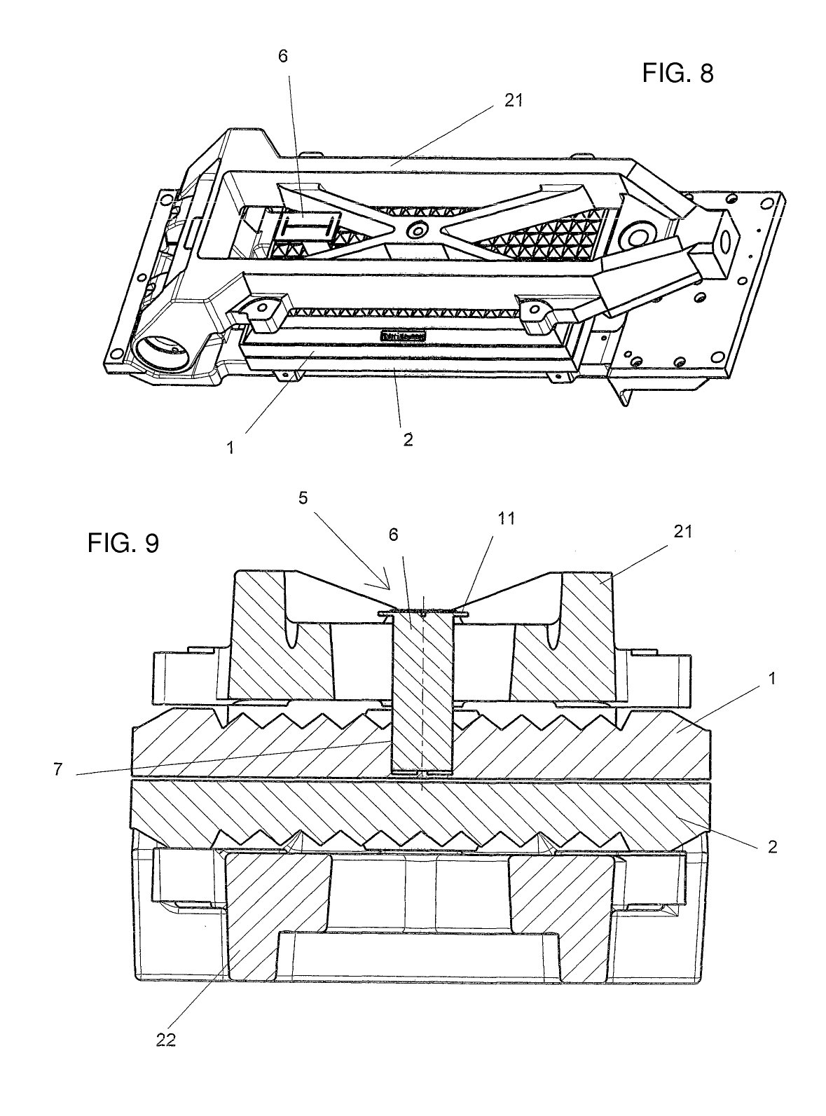

FIGS. 8 and 9 show an oblique view and a sectional view of an exemplary embodiment for a baking tong, where the baking plates are not self-supporting but arranged in a supporting frame.

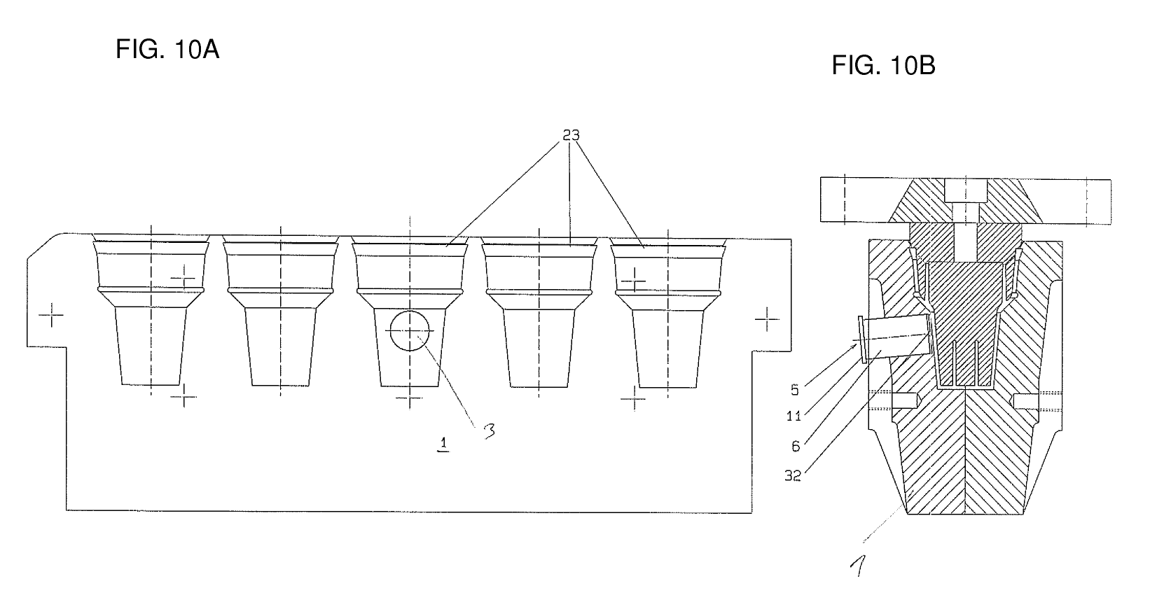

FIG. 10a, b show the inside view of a baking plate half for poured three-dimensional wafer products and the sections through the central die when the mould is closed.

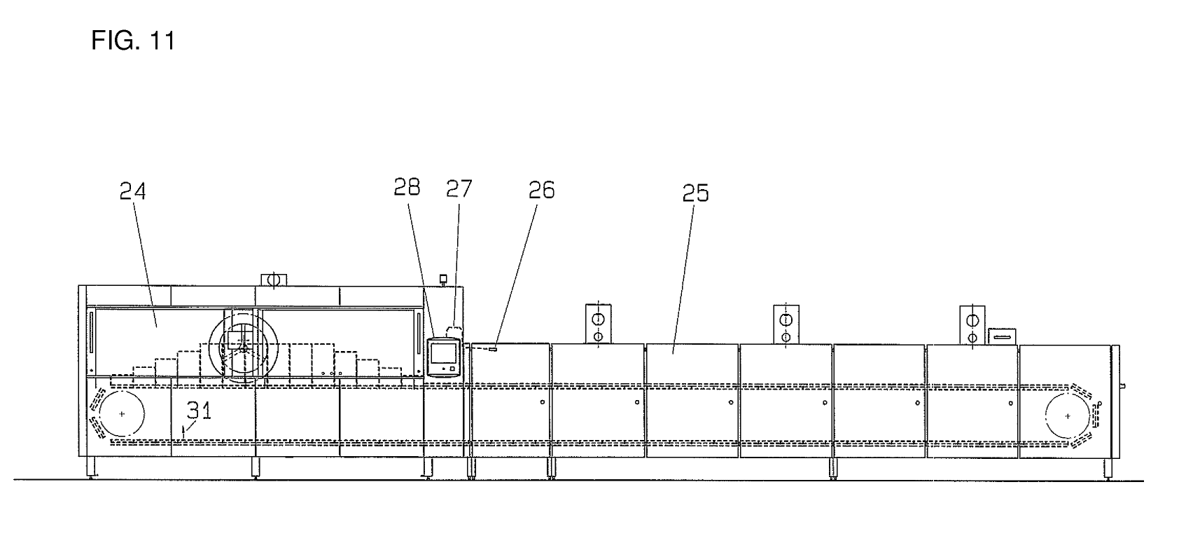

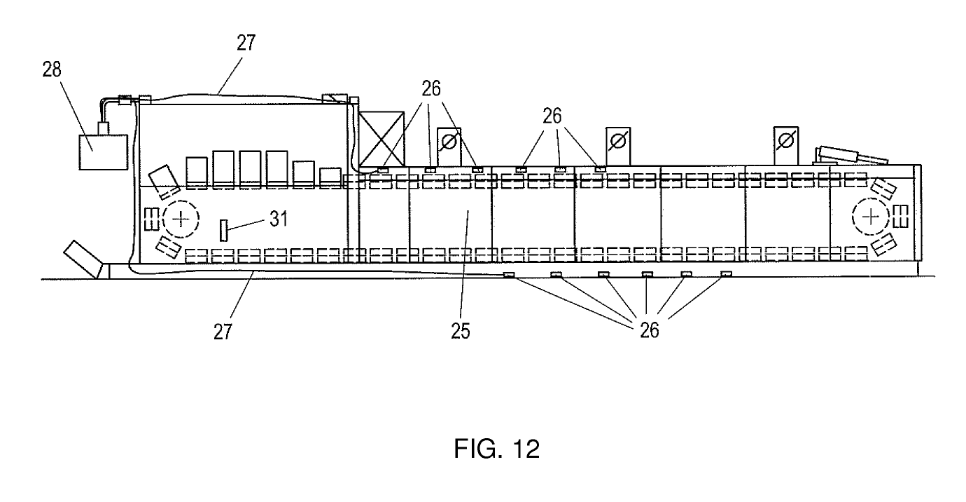

FIGS. 11 and 12 show two side views of baking ovens in which the baking plates according to the invention can be used with relevant evaluation and reading devices.

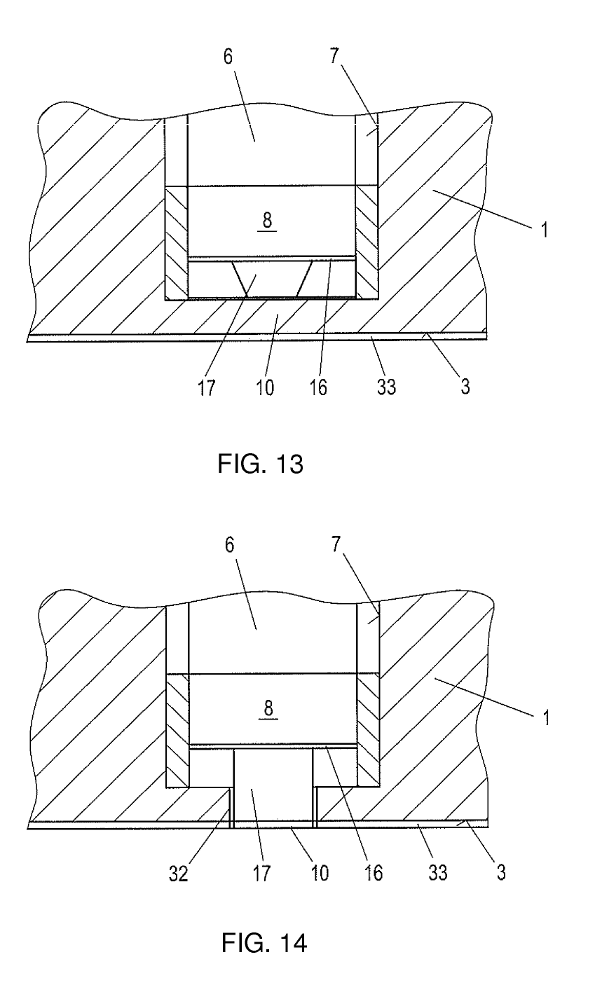

FIGS. 13 and 14 show schematic alternative details.

FIGS. 1 to 3 show baking plates according to the invention whose fundamental structure corresponds to the prior art. The embodiment shown shows an upper baking plate 1 and a lower baking plate 2, where these comprise self-supporting baking plates which do not require a supporting frame. In the closed state shown the two baking plates abut against one another at the baking surfaces to such an extent that only the required gap 4 for the dough to be baked remains between the baking surfaces. The baking surfaces can be provided with a fluting in a manner known per se as is known from flat wafers or soft waffles. This fluting is not shown in FIGS. 1 to 3.

As shown in FIG. 2 in section, the upper baking plate has a sensor device 5 in the form of an individual sensor 6. The sensor 6 is disposed in a sensor receiving opening 7 in the baking plate, where in this exemplary embodiment the sensor with its sensor head 8 extends close to the baking surface 3 of the baking plate 1.

As can also be seen in FIG. 2, the sensor receiving opening 7 is substantially orthogonal to the baking surface 3 and the sensor receiving opening extends from the baking plate back 9 into the baking plate.

As will be explained in further detail subsequently with reference to FIG. 4, the sensor with its sensor head 8 extends close to the baking surface 3, where a thin layer of the material of the baking plate remains between the baking surface 3 and the sensor head or the sensor membrane which terminates the sensor head. The thin region of the baking plate is designated subsequently as measuring section 10. Located at the other end of the sensor 6 is the sensor antenna 11 which according to FIG. 1 is configured as an H-slot antenna. The diagrams in these figures are only purely schematic.

FIG. 3 shows an example for the specific arrangement of the baking plates 1 and 2 in a baking tong. The baking tong can be opened in a known manner and closed again by pivoting the upper baking tong 1 about the baking tong joint 12. The baking tong forms with the rollers 13 the baking tong carriage and a plurality of such baking tong carriages arranged in a row form the baking tong chain which is guided over an orbit. The control roller 14 is used to control the folding movement of the upper baking plate 1.

Further details on the operating mode of such baking devices can be deduced, for example, from the prior art mentioned initially and reference is particularly made to this.

For the arrangement of the sensor 6 with the sensor antenna 11, it should also be said that this antenna and its reflector plate 15 should lie as close as possible to the baking plate without however restricting the functionality of the antenna. The sensor antenna 11 can also lie in a slight recess of the baking plate or the baking plate ribs.

FIG. 4 shows an exemplary embodiment for the arrangement of the sensor 6 in the baking plate.

The sensor is inserted in the sensor receiving opening 7 and is held by an annular clamping element 30 where this sensor receiving opening is configured as a stepped blind hole. The sensor comprises the sensor head 8 which is closed with the sensor membrane 16 towards the bottom. The sensor receiving opening 7 extends very close to the baking surface 3 of the baking plate, where a measuring section 10 exists between the baking surface and the sensor membrane 16 which is sufficiently thin to relay temperature and pressure relationships on the baking surface 3 rapidly to the sensor head 8.

For contact and relaying the parameters between the measuring section 10 and the sensor membrane 16, there is provided a stamp 17 which in the present exemplary embodiment is configured as a small continuation of the measuring section 10 which extends in the direction of the sensor membrane 16.

It is obviously at the discretion of the person skilled in the art to provide the stamp 17 alternatively as part of the sensor membrane 16 and let the stamp act downwards towards the measuring section 10, as shown in FIG. 13.

The wall thickness of the measuring section 10 is indicated by the reference number 18 and in practice lies between 0.5 and 5 mm, preferably between 1 and 3 mm. The wall thickness of the measuring section depends on the material of the baking plate and the sensitivity of the sensor. It is essential that temperature and pressure can be determined by the sensor in sufficient time and to sufficient extent.

The measuring section 10 comprises a surface area which is approximately indicated by the arrow 29.

A cavity 19 is provided in the sensor head 8 for the actual measuring component of the sensor, in particular the substrate-supported piezocrystal, where the structure of this measurement-sensitive sensor arrangement inside the sensor forms a separate invention and is not shown further here. It is essential that the parameters pressure and temperature transmitted through the measuring section 10 or one of these parameters can be relayed with appropriate accuracy as a signal to the sensor antenna 11.

Located above the sensor head 8 is an insulation shaft 20 whose longitudinal extension overcomes the thickness of the baking plate. The reflector plate 15 sits on the insulation shaft 20. Not shown is the electrical lead which extends inside the sensor from the sensor head 8 as far as the antenna 11 and naturally must withstand the high temperatures of a baking oven.

FIG. 5 is merely intended to illustrate that instead of in the upper baking plate 1, the sensor 6 can also be disposed in the lower baking plate 2. Similarly FIG. 6 shows the multiple arrangement of sensors either in the lower and/or upper baking plate, in the present example the arrangement of three sensors in the upper baking plate as sensor device. FIG. 7 shows the arrangement of respectively one sensor in the lower and upper baking plate.

FIGS. 8 and 9 illustrate the arrangement of a sensor 6 in another embodiment of baking tongs, where the baking plates are not configured to be self-supporting but are mounted in a supporting frame 21, 22. This fundamental design of a baking plate can also be deduced from the prior art and requires no further explanation since the type of assembly of the baking plates alone is not essential to the invention in the present case. The person skilled in the art also identifies that the tong carriage shown comprises a baking plate without locking such as is used, for example, for the production of soft waffles or for the production of baked flatbreads for the subsequent formation of wafer cones. In the same way however, a sensor can also be provided for tong carriages with locking.

The supporting frame is indicated as upper supporting frame 21 and lower supporting frame 22. The sensor 6 sits in its sensor receiving opening 7 in the upper baking plate 1. The sensor extends here so far upwards that it is protected by the supporting frame 21 but the effect of the sensor antenna 11 is not diminished.

FIG. 10a shows schematically the inner view of a die half to produce poured wafer cones, where the sensor 6 is inserted in one of the die recesses 23, where its own baking surface 32 is provided for the sensor 6, on which pressure and/or temperature can be measured in similar manner. FIG. 10b shows the cross-section through the central die in the closed state.

FIG. 11 shows schematically an overview of the entire baking device. After the dispensing-input station 24, the baking plates provided with the sensor or sensors travel into the baking chamber 25 of the oven. Located in the initial section of the baking chamber is the reader of a radio antenna which emits its electromagnetic field in the direction of the sensors of the passing baking tongs. As a result of the measurement parameters of the sensors, the electromagnetic field varies in characteristic manner, which can be evaluated by the reading device 26. The reading device delivers its signals via the antenna cabling 27 to the evaluation device 28, which for example comprises a display for the operator of the baking device, where the display can output appropriate warnings in the event of variations of the baking parameters. The evaluation device can however also provide independent regulation of the baking parameters.

The precise arrangement of the reading devices or a multiplicity of reading devices along the process section for the baking process can be arbitrary and selected according to the circumstances. FIG. 12 shows, for example, in the initial part of the baking chamber the arrangement of six reading devices 26 and in addition, a further six reading devices in the returning part of the baking tong chain. This is only to explain that there are numerous possible arrangements. It is therefore possible to track the entire process behaviour of each baking plate and to bring about an optimisation of the baking process.

FIG. 12 also shows schematically the position display 31 which displays the arrangement in which the baking tong chain is located. The precise assignment of the measurement data delivered by the reading devices 26 to the baking plates and their position in the baking oven is thereby possible.

FIG. 13 shows schematically an alternative to the arrangement of the sensor in the sensor receiving opening 7. The stamp 17 which is responsible for transmitting the measured quantities to the sensor head 8 is a fixed component of the sensor membrane 16 and projects downwards to the measuring section 10 of the baking plate. The fluting 33 of the baking surface 3 is not interrupted since the measuring section 10 is continuously one-piece with the baking plate 1.

FIG. 14 shows another alternative to the configuration of the measurement arrangement. The sensor receiving opening 7 extends over a section 32 with reduced diameter into the baking surface 3 so that a continuous opening is present. The stamp 17 extends from the sensor membrane 16 through the section 32 as far as the baking surface 13. If the measurement point of the stamp 17 should not be visually identifiable on the finished wafer product, the stamp 17 can also be provided continuously with the fluting.

### REFERENCE LIST

1 Upper baking plate
2 Lower baking plate
3 Baking surface
4 Gap
5 Sensor device
6 Sensor
7 Sensor receiving opening
8 Sensor head
9 Baking plate back
10 Measuring section
11 Sensor antenna
12 Baking tong joint
13 Rollers
14 Control roller
15 Reflector plate
16 Sensor membrane
17 Stamp
18 Arrow
19 Cavity
20 Insulation shaft
21 Upper supporting frame
22 Lower supporting frame
23 Die recess
24 Dispensing-input station
25 Baking chamber
26 Radio antenna, reading device
27 Antenna cabling
28 Evaluation device
29 Arrow
30 Annular clamping element
31 Position display
32 Section
33 Fluting

1-21. (canceled)

22. An apparatus for producing baked products, the apparatus comprising:
at least one baking plate for moving through a baking chamber during baking, said baking plate having a baking surface to be heated to a baking temperature; and
a sensor device disposed in said baking plate, said sensor device detecting at least one of a temperature of said baking plate or a pressure acting on said baking surface of said baking plate during a baking process.

23. The apparatus according to claim 22, wherein:
said baking plate has a sensor receiving opening formed therein; and
said sensor device contains at least one sensor having a sensor head, said sensor disposed in said sensor receiving opening in said baking plate so that said sensor with said sensor head lies on said baking surface or comes to rest in close proximity to said baking surface.

24. The apparatus according to claim 23, wherein said baking plate has a rear side and a measuring section, said sensor receiving opening is configured to extend from said rear side of said baking plate to said measuring section in close proximity to said baking surface, wherein said baking surface and said measuring section run through continuously.

25. The apparatus according to claim 24, wherein said sensor receiving opening penetrates from said rear side of said baking plate through said baking plate and said sensor head has a sensor membrane lying on said baking surface and is profiled to match said baking surface.

26. The apparatus according to claim 25, wherein said measuring section of said baking plate has a stamp projecting towards said sensor head or said sensor membrane for transmitting measurement values acting on said measuring section.

27. The apparatus according to claim 25, wherein said sensor membrane has a stamp projecting towards said measuring section.

28. The apparatus according to claim 24, wherein said measuring section has a wall thickness between 1 and 3 mm.

29. The apparatus according to claim 23, further comprising an annular clamping element, said sensor receiving opening is configured as a blind hole projecting into said baking plate and said sensor with said sensor head is cylindrically shaped and is fastened in said baking plate by means of said annular clamping element.

30. The apparatus according claim 23, wherein said sensor is a passive temperature-pressure sensor which can be interrogated by an electromagnetic field, said sensor has a rear side with a sensor antenna for transmission of energy and information.

31. The apparatus according to claim 30, wherein said sensor antenna is an H-slot antenna.

32. The apparatus according to claim 31, wherein said sensor has a shaft and a reflector plate disposed below said sensor antenna and is fastened to said sensor head or said shaft.

33. The apparatus according to claim 23, further comprising at least one reading device assigned to said sensor, said reading device produces and evaluates an electromagnetic field.

34. The apparatus according claim 23, wherein said sensor is adapted to deliver information relating to the pressure, a temperature and an identification feature characteristic of said sensor.

35. The apparatus according to claim 23, wherein said sensor device has a plurality of sensors disposed in said baking plate.

36. The apparatus according to claim 33, further comprising baking tongs and said baking plate is a part of said baking tongs circulating in a baking oven, said baking tongs each containing a lower and an upper baking plate and said baking tongs in a closed position loaded with dough are movable through the baking chamber, and said sensor device has at least one sensor disposed on at least one of said upper baking plate or said lower baking plate.

37. The apparatus according to claim 36, wherein at least one of said baking plates circulating in the baking oven is provided with at least one said sensor device.

38. The apparatus according to claim 37, wherein said sensor device is one of a plurality of sensor devices and a plurality of said baking plates for the baking oven have one of said sensor devices.

39. The apparatus according to claim 36, further comprising a position display in the baking oven for displaying a position of each of said baking tongs and respective said baking plates each provided with said sensor device to be able to assign each measured value read by said reading device to a specific one of said baking plates of said baking tong and a position of said baking tong in the baking oven.

40. The apparatus according to claim 22, further comprising:
an evaluation device; and
a plurality of reading devices disposed consecutively in the baking chamber and successively read measured values and identification features of said sensor device of said baking plate is fed to said evaluation device.

41. The apparatus according to claim 23, wherein said sensor is a SAW sensor based on piezoelectric substrate crystals.

42. The apparatus according to claim 22, wherein the apparatus is for producing edible crispy wafers or soft waffles.

43. A baking oven for producing baked products, comprising:
baking tongs each having two successively disposed baking plates for baking the baked products;
an oven frame defining a baking chamber and having an external thermal insulation;
a conveying device having a baking tong chain;
said baking tongs circulating in the baking oven and being disposed along an orbit leading through said baking chamber and said baking tongs being conveyed by said conveying device along the orbit through the baking oven;
said oven frame on a part of the orbit disposed outside said baking chamber having:
a device for opening said baking tongs;
a dispensing station for dispensing the baked products;
a loading station for loading said baking tongs;
a device for closing said baking tongs in a running direction of said baking tongs disposed consecutively;
a monitoring device integrated in said oven frame for detecting work activity of the baking oven and a baking process taking place in said baking tongs;
said baking tongs each containing a sensor device having at least one sensor disposed on a respective one of said baking tongs, said sensor device detecting the baking process taking place in said respective baking tong, and being a passive sensor to be interrogated by an electromagnetic field;
a transmitting and receiving device disposed fixedly in said oven frame and containing at least one reading device disposed on the orbit of said baking tong chain, said transmitting and receiving communicating via the electromagnetic field with said sensor of said sensor device; and
an evaluation device processing signals coming from said sensor via said reading device and produces monitoring signals.
